(19) United States
(12) Patent Application Publication
(10) Pub. No.: US 2008/0055604 A1
(43) Pub. Date: Mar. 6, 2008

(54) APPARATUS, METHOD AND COMPUTER PROGRAM PRODUCT FOR INTERROGATING AN OPTICAL SENSING ELEMENT

(75) Inventors: Jonathan Josef Sapan, Brookline, MA (US); Min-Yi Shih, Carson City, NV (US); Samhita Dasgupta, Niskayuna, NY (US); Aaron Jay Knobloch, Mechanicville, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/470,371

(22) Filed: Sep. 6, 2006

(51) Int. Cl. G01J 3/45

(52) U.S. Cl. 356/454; 356/451

(57) ABSTRACT

A method for determining deflection of an optical sensor having an optical cavity includes: providing an optical signal including a train of time spaced light pulses, each light pulse including a known set of wavelengths; splitting the optical signal and providing a portion of the optical signal to a reference path; detecting light pulses in the portion of the optical signal; using a remaining portion of the optical signal and interrogating the sensor; receiving a reflected optical signal from the sensor; detecting light pulses in the reflected optical signal; and analyzing the portion of the optical signal and the reflected optical signal to determine the deflection. Corresponding apparatus and computer program products are provided.

### BACKGROUND OF INVENTION

1. Field of the Invention

The present invention relates to an optical sensing structure, and in particular, to techniques for measurement therewith, wherein the techniques are independent of optical intensity fluctuations and other similar sources of measurement error.

2. Brief Description of the Related Art

In optics, a Fabry-Pérot interferometer is typically made of a transparent plate with two reflecting surfaces. Fabry-Pérot interferometers are one of the most common types of optical cavity used in laser construction. Due to the versatile uses of the interferometers, the structures are sometimes referred to in generic terms as sensors.

In some instances, an extrinsic Fabry-Perot interferometer may be fabricated on a silicon wafer. Such embodiments of the extrinsic Fabry-Perot interferometer includes a cavity covered by a silicon diaphragm which deflects under pressure. The structure is illuminated with visible or infrared light and a varying amount of that light is both reflected from and transmitted through the structure. Some amount of deflection occurs in the diaphragm as a result of applied pressure. The optical properties of the structure are dependent upon the deflection and the reflected or transmitted light will vary with any of the pressure, strain and stress upon the structure (where each quantity may be measured and expressed as a measurand). The reflected or transmitted optical signal may also vary due to undesired fluctuations in the incident optical power due to any number of causes (inherent fluctuations in the light source, bending of optical fibers, etc.).

The structure has a certain reflectivity which is wavelength dependent. That wavelength dependence changes at different pressures. So, instead of measuring raw reflected power (which may fluctuate for reasons other than changes in the measurand), a spectral shift in the reflected optical signal may be used to determine pressure change. Comparing signals from filtered and unfiltered diodes provides one technique for evaluating spectral shift, and is known in the art.

However, in order for use of the filter approach to work well, it is desirable to use a source with a rather broad spectrum (e.g., an LED). However, LEDs typically provide only a certain amount of light for a fiber. This means that optical signal levels may be lower than desired, thus resulting in lower sensitivity, higher noise, and other such factors. Although a spectrometer could be used, one skilled in the art will readily recognize that this is not practical at least for cost and complexity reasons.

Therefore, what is needed is a technique for measuring output of a Fabry-Pérot interferometer that is not dependent upon optical intensity fluctuations arising form external factors such as pressure fluctuations.

### BRIEF DESCRIPTION OF THE INVENTION

Disclosed is an apparatus for measuring deflection of an optical sensor, the apparatus including: at least one light source for providing an optical signal including a train of time spaced light pulses, each light pulse including a known set of wavelengths; a first optical coupler for receiving the optical signal, splitting the optical signal and providing a portion of the optical signal to a first optical detector on a reference path; a second optical coupler for receiving a remaining portion of the optical signal, providing an interrogation light for interrogating the sensor including an optical cavity, receiving and providing a reflected light to another optical detector; wherein each detector is coupled to electronics for analyzing the train of time spaced light pulses.

Also disclosed is a method for determining deflection of a Fabry-Perot cavity, including: providing an optical signal including a train of time spaced light pulses, each light pulse including a known set of wavelengths; splitting the optical signal and providing a portion of the optical signal to a reference path; detecting light pulses in the portion of the optical signal; using a remaining portion of the optical signal and interrogating the cavity; receiving a reflected optical signal from the cavity; detecting light pulses in the reflected optical signal; and analyzing the portion of the optical signal and the reflected optical signal to determine the pressure at the sensor.

Further disclosed is a computer program product stored on machine readable media, the product for determining deflection of a Fabry-Perot based sensor, the instructions including: providing an optical signal including a train of time spaced light pulses, each light pulse including a known set of wavelengths; splitting the optical signal and providing a portion of the optical signal to a reference path; detecting light pulses in the portion of the optical signal; using a remaining portion of the optical signal and interrogating the sensor; receiving a reflected optical signal from the sensor; detecting light pulses in the reflected optical signal; and analyzing the portion of the optical signal and the reflected optical signal to determine the deflection.

### BRIEF DESCRIPTION OF THE DRAWINGS

Referring now to the drawings wherein like elements are numbered alike in the several figures, wherein:

FIG. 1 depicts an interferometer (as a sensor) optically coupled to an optical fiber;

FIG. 2 depicts a physical coupler configuration;

FIG. 3 depicts an interrogation scheme;

FIG. 4 depicts an output of the interrogation scheme; and

FIG. 5 depicts an exemplary method for analyzing pressure using the sensor.

### DETAILED DESCRIPTION OF THE INVENTION

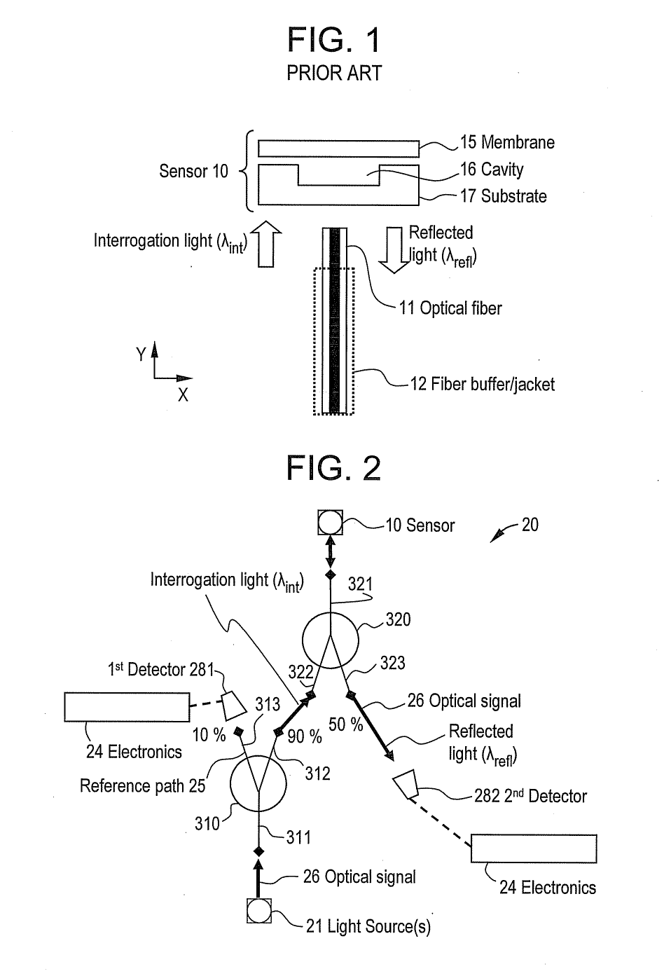

Referring now to FIG. 1, there are shown aspects of a prior art Fabry-Perot Interferometer, simply referred to as an interferometer, and more broadly, as a sensor 10. One skilled in the art will recognize that the illustration is merely introductory and is not limiting of the teachings herein.

In this exemplary embodiment, the interferometer as the sensor 10 includes a membrane 15. In this embodiment, the membrane 15 is formed of single crystal silicon (Si) or gallium nitride (GaN). A cavity 16 of the interferometer is formed in a substrate 17 of silicon dioxide (SiO₂) or sapphire (Al₂O₃). Exemplary designs include pairings of Si with SiO₂ and GaN with Al₂O₃. These pairings are preferred for various reasons. For example, a GaN membrane would perform at much higher temperatures than a Si membrane. SiO₂ and Si are compatible from a semiconductor processing standpoint, as are GaN and sapphire (Al₂O₃).

An optical fiber 11 for interrogating the interferometer includes a high quality quartz or sapphire multimode fiber, having a core diameter of about 50 μm. In FIG. 1, the optical fiber 11 includes a jacket 12 for protection of the optical portion.

Typically, optical fibers 11 are coated with a polymer jacket 12 (also referred to as a “buffer”) for providing mechanical durability. However, polymer jackets 12 typically are not suitable for high temperature applications (usually greater than about 80 degrees Celsius). “High temperature” optical fiber 11 using a polyimide jacket 12 is available. Typically, high temperature optical fiber 11 is stable to about 350 degrees Celsius. Other designs of optical fibers 11 for high temperature applications are known. For example, some high temperature optical fibers 11 are coated with various metals. Metal coated optical fibers 11 are known to be stable at temperatures to over 700 degrees Celsius. However, with regard to the teachings herein, and within the package of the interferometer, uncoated optical fiber 11 may be used.

Although the teachings herein are disclosed in terms of the interferometer as the sensor 10, aspects may be useful with or relate to other types of optical sensors 10. Accordingly, the term “sensing element” and “sensor” may be considered to be equivalent to the interferometer in at least some instances. Therefore, one skilled in the art will note that the interferometer is merely one embodiment of an optical sensor 10.

Wavelengths of light travel through the optical fiber 11 and are communicated into the sensor 10 as interrogation light (λᵢₙₜ) The wavelengths are reflected by the sensor 10 and into the optical fiber 11 as reflected light (λ_{ref1}) The travel of light is depicted by the directional arrows in FIG. 1. As properties of interferometers are known, these are generally not discussed in greater detail herein.

At least one light source provides a plurality of wavelengths (λₙ). More specifically, the light source provides sets of wavelengths that are detectably distinct from each other. As used herein, “detectably distinct” refers to capabilities of electronics selected for signal analysis to reliably provide discriminations between the sets of wavelengths. A degree of reliability is typically selected by a user of a measurement apparatus to which the components disclosed herein are a part.

The plurality of sets of wavelengths (λₙ) includes at least a first set of wavelengths (λ₁) and a second set of wavelengths (λ₂). The light source is capable of providing light pulses (tₙ), wherein each light pulse (tₙ) includes light included in a known set of wavelengths. For example, a first light pulse (tₙ) may include light within the first set of wavelengths (λ₁), while a second light pulse (tₙ) may include light within the second set of wavelengths (λ₂).

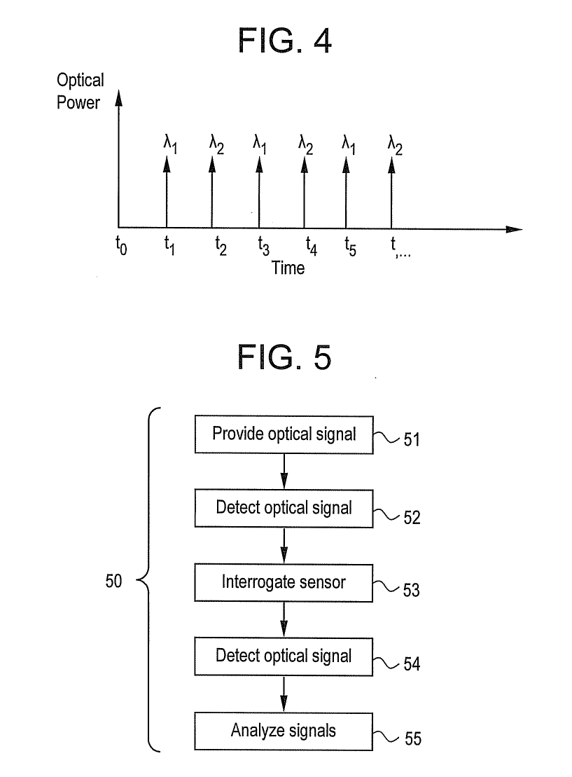

A series (or “train”) of time spaced light pulses (tₙ) provides the interrogation light (λᵢₙₜ) for interrogation of the sensor 10. Typically, the train of light pulses (tₙ) includes light pulses (tₙ) of alternated or varied wavelengths. For example, in one embodiment, the interrogation light (λᵢₙₜ) may include a train of light pulses (tₙ) wherein odd numbered light pulses (tₙ) are within the first set of wavelengths (λ₁), while even numbered light pulses (t₂, t₄, t₆, t_{n*2}, . . . ) are within the second set of wavelengths (λ₂). Reference may be had to FIG. 4.

Referring now to FIG. 2, an exemplary embodiment of a measurement apparatus 20 is provided. In FIG. 2, at least one light source 21 provides an optical signal 26 to a first optical coupler which is referred to as a source optical coupler 310. The source optical coupler 310 of the present embodiment is a one by two optical coupler. A second optical coupler, referred to as a sensor optical coupler 320, is in optical communication with the source optical coupler 310 and is also is a one by two optical coupler.

Each of the source optical coupler 310 and the sensor optical coupler 320 includes a common optical path, a first optical path and a second optical path. For example, the source optical coupler 310 includes a source common optical path 311, a source primary optical path 312 and a source second optical path 313; while the sensor optical coupler 320 includes a sensor common optical path 321, a sensor primary optical path 322 and a sensor second optical path 323.

Each optical coupler 310, 320 provides for a coupling with an optical fiber 11 for conveying an optical signal 26. Of course, one skilled in the art will recognize that the use of optical couplers (which may be considered beamsplitters), may call for fewer or more of such devices. For example, in one embodiment, a single optical coupler or beamsplitter may be used, and may include additional paths for optical signals. Accordingly, the use of two optical couplers is merely exemplary and not limiting of the teachings herein.

The common source optical path 311 is optically coupled to the light source 21. The light source 21 provides light pulses with at least two sets of wavelengths. Typical devices for the light source 21 include two discrete light sources (individual laser diodes), either coupled directly to a single optical fiber 11 or coupled to the optical fiber 11 by use of another fiber optic coupler or splitter.

Light from the light source 21 is split at a junction in the source optical coupler 310. As depicted in FIG. 2, about 10% of the light from the light source 21 is directed into the second source optical path 313, while about 90% of the light from the light source 21 is directed into the primary source optical path 312 for interrogation of the sensor 10.

In this embodiment, the second source optical path 313 provides a reference path 25 for light from the light source 21. A first detector 281 receives the portion of the interrogation light (λᵢₙₜ) on the reference path 25, thus providing for collection of information regarding interrogation light (λᵢₙₜ) prior to interrogation of the sensor 10.

The sensor optical coupler 320 communicates the interrogation light (λᵢₙₜ) from the sensor primary optical path 322 to the sensor common optical path 321 and interrogates the sensor 10.

Once reflected in the sensor 10, the interrogation light (λᵢₙₜ) is received by the sensor common optical path 321. The reflected light (λ_{ref1}) is provided as the optical signal 26 which is measured by use of the sensor second optical path 323. Typically, in this embodiment, about 50% of the reflected light (λ_{ref1}) is communicated through the second sensor optical path 323.

In one embodiment, a maximum power reflectivity of the sensor 10 is about 50% of the interrogation light (λᵢₙₜ) and the reflected optical power is between about 0% and about 22.5% of the incident power for the light source 21.

Detection and analysis of the various optical signals (i.e., the interrogation light (λᵢₙₜ) and the reflected light (λ_{ref1}) is achieved through the use of optical detectors 281, 282. In typical embodiments, the light source 21 is of broad spectral width (such as through use of a light-emitting-diode LED). As discussed, the first detector 281 measures light pulses (tₙ) in the interrogation light (λᵢₙₜ) on the reference path 25. A second detector 282 measures the reflected light (λ_{ref1}) following interrogation of the sensor 10.

The detectors 281, 282 used to measure the optical signal 26 are coupled to electronics 24 as are known in the art for resolving optical signals. Accordingly, the electronics 24 are neither shown nor discussed in greater depth herein.

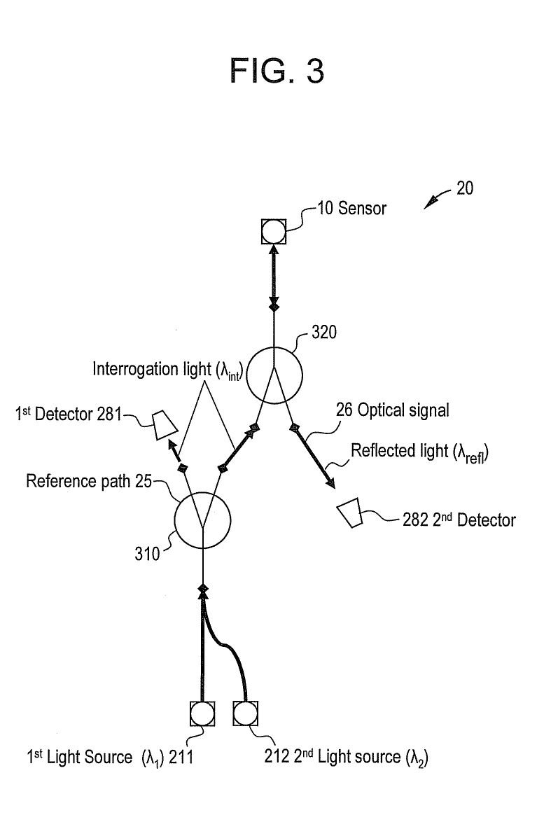

Now with reference to FIG. 3, aspects of another embodiment are depicted. In FIG. 3, a plurality of light sources are used to provide the plurality of sets of wavelengths (λₙ) for interrogating the sensing element 10. In this example, the plurality of light sources includes a first light source 211 providing the first set of wavelengths (λ₁) and a second light source 212 providing the second set of wavelengths (λ₂).

A portion of the optical signal 26 is split off onto the reference path 25 using the first optical coupler 310. The portion is used as a reference and measured by the first detector 281 (such as a photodiode), while the rest of the optical signal 26 is directed to the sensing element 10. The optical signal 26 returns via the second optical coupler 320 to the second detector 282.

In typical embodiments, the spectral response for each detector 281, 282 has been previously characterized. In order to measure the reflected light (λ_{ref1}), each of the light sources 211, 212 is pulsed in a predetermined sequence. Known techniques, such as the use of an integrated circuit (e.g., a microprocessor), are applied to record the response of each detector 281, 282 (for example, the amplitude of the current generated in each photodiode) for each of the light pulses (tₙ). Various devices may be used as detectors 281, 282, such as, for example, standard diodes and semiconductor diodes.

Typically, a background signal is ascertained for each detector 281, 282 between light pulses (tₙ). For example, in the case where the detectors 281, 282 are photodiodes, a dark current is measured.

In some embodiments, and once the signal for each of the light pulses (tₙ) and the background signal between the light pulses (tₙ) are determined, the optical signal 26 is determined. In these embodiments, the optical signal 26 is determined by subtraction of the background signal from the optical signal 26 for each light pulse (tₙ). Determinations and use of the background signal in this fashion provides for accurate determinations of the signal-to-noise ratio (SNR). In general, it is considered that the background signal is the measured optical power in the absence of a light pulse.

For example, and more specifically, with regard to use of photodiodes and an integrated circuit (IC), the IC determines a voltage or current which is determined by a relationship between the optical signal 26 detected for different sets of wavelengths (λ₁, λ₂), after subtracting the instantaneous background signals. The values obtained for the optical signal 26 and reference diodes are compared and a final value is output.

Time division multiplexing (TDM) of discrete sources is used to relate the plurality of light sources 21 to the sensor 10 using one optical fiber 11. Use of a plurality of sets of wavelengths (λₙ) provides for measurement of multiple optical signals 26 which exhibit a relationship that is dependent only upon the measurand.

For example, and with reference to FIG. 4, background signals are measured prior to output of a light pulse (time t₀). Then, the first light source 211 is pulsed, producing a first light pulse (t₁) for the set of the first wavelengths (λ₁). The second light source 212 is then pulsed, producing a second light pulse (t₂) for the set of the second wavelengths (λ₂). Each set of wavelengths in the plurality of wavelengths is at least functionally distinct from the other sets of wavelengths.

It should be noted that as used herein “distinct from the other sets of wavelengths” and similar terminology (such applications of “discrete”) refers to an ability to resolve each set of wavelengths when malting measurements. That is, the optical signal 26 associated with one set of wavelengths may be substantially resolved from the optical signal 26 associated with another set of wavelengths. Typically, the resolving is performed using commercially available equipment for producing, measuring and analyzing the light pulses (tₙ).

The height of each light pulse (tₙ) is dependent upon, among other things, the optical power of the at least one light source 21. Other factors include the length of the optical fiber used and optical signal loss therein. Accordingly, accurate determination of each light pulse (tₙ) is desirable and of particular importance for weak signals (such as in the case of remote light sources).

One technique for analysis of the optical signal 26 calls for taking a ratio of responses (i.e., time between light pulses (tₙ)) at the second detector 282 between the first set of wavelengths (λ₁) and second set of wavelengths (λ₂) (usually after background subtraction). The resulting ratio is divided by a ratio obtained at reference detector 281 for the first set of wavelengths (λ₁) and second set of wavelengths (λ₂) (after background subtraction).

Of course, various analyses regarding the plurality of sets of wavelengths (λₙ) may be performed. That is, techniques other than determination of ratios may be used. For example, simple subtraction of the optical signal 26 for the reflected light (λ_{ref1}) from the optical signal 26 for the interrogation light (λᵢₙₜ) may provide useful information.

Among other things, results obtained include capabilities to obtain information regarding ambient environmental conditions (i.e., environmental pressure) for the sensor 10. In some embodiments, interrogation of the sensor 10 provides results regarding fiber-optic strain.

The teachings herein provide the technical effects of various improvements over the prior art. For example, elimination of the use of optical filters and multiple diodes for both the optical signal 26 and reference signals may be realized. Fewer optical couplers (splitters) are required. Discrete laser diodes may be used to achieve the same functionality as an LED, while providing significantly more optical power when coupling to fiber optics, while consuming less electrical power and generating less heat. Further, time division multiplexing of sources provides for real-time measurement of dark currents during intervals between light pulses. The real-time measurement of dark current provides for background subtraction as well as any compensation needed for temperature of the electronics.

Other advantages are also realized over the prior art. For example, filters are no longer warranted since wavelength analysis is being done on a temporal basis. Thus, the teachings provide for reducing the number of light sources (diodes) needed (when compared to the prior art, this provides for a reduction of diodes from 4 to 2). Further, splitting the signal immediately provides for a greatly improved signal to noise ratio (since the first detector 281 now sees twice as much signal). Also of note, narrow-band sources such as laser diodes may be used as the wavelength resolution of the system is not dependent upon the characteristics of a filter.

In the exemplary embodiment, the techniques provide for measurement by monitoring the light reflected from the optical cavity 16 in a Fabry-Perot interferometer. The Fabry-Perot interferometer has a “flexible” surface which deforms with stress. However, one skilled in the art will recognize that the TDM approach could also be used with other optical sensors. Non-limiting examples include Fiber-Bragg-Grating (FBG) sensors and other optical sensors having an optical cavity subject to deflection induced optical variations. In the case of FBG sensors, in many cases people talk about using multiple FBGs, each with a particular wavelength response. By using TDM, one could interrogate each FBG in a sensor at different times rather than having multiple filtered diodes or WDM (wavelength division multiplexing) couplers.

In an exemplary method 50 for time division multiplexing (TDM), the measuring apparatus 20 provides the train of time spaced optical signals in a first step 51, detects the train of time spaced optical signals in a second step 52, interrogates the sensor 10 in a third step 53, detects the reflected light (λ_{ref1}) in a fourth step 54 and analyzes the train of time spaced optical signals in a fifth step 54.

The capabilities of the present invention can be implemented in software, firmware, hardware or some combination thereof. As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, aspects of the steps may be performed in a differing order, steps may be added, deleted and modified as desired. All of these variations are considered a part of the claimed invention.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for measuring deflection of an optical sensor, the apparatus comprising:
at least one light source for providing an optical signal comprising a train of time spaced light pulses, each light pulse comprising a known set of wavelengths;
an optical coupler for receiving the optical signal, splitting the optical signal and providing a portion of the optical signal to a first optical detector on a reference path; the optical coupler for receiving a remaining portion of the optical signal, providing an interrogation light for interrogating the sensor comprising an optical cavity, receiving and providing a reflected light to another optical detector; wherein each detector is coupled to electronics for analyzing the train of time spaced light pulses.

2. The apparatus as in claim 1, wherein the train of time spaced light pulses comprises at least two sets of wavelengths.

3. The apparatus as in claim 2, wherein wavelengths in one set of wavelengths are substantially separate from wavelengths in other sets of wavelengths.

4. The apparatus as in claim 1, wherein the at least one light source comprises at least one of a light emitting diode (LED), a laser diode and a broad spectrum of wavelengths.

5. The apparatus as in claim 1, wherein each detector comprises one of a standard diode, a silicon photodiode and a semiconductor diode.

6. The apparatus as in claim 1, wherein the sensor comprises one of a Fabry-Perot interferometer and a Fiber-Bragg-Grating sensor.

7. The apparatus as in claim 1, wherein the optical signal is communicated by an optical fiber.

8. A method for determining deflection of a Fabry-Perot cavity, comprising:
providing an optical signal comprising a train of time spaced light pulses, each light pulse comprising a known set of wavelengths;
splitting the optical signal and providing a portion of the optical signal to a reference path;
detecting light pulses in the portion of the optical signal;
using a remaining portion of the optical signal and interrogating the cavity element;
receiving a reflected optical signal from the cavity;
detecting light pulses in the reflected optical signal; and
analyzing the portion of the optical signal and the reflected optical signal to determine the deflection.

9. The method of claim 8, wherein providing further comprises providing a plurality of sets of wavelengths in the train.

10. The method of claim 8, wherein providing further comprises providing a known of set of wavelengths for each light pulse.

11. The method of claim 8, further comprising characterizing wavelength response of each detector used for the detecting.

12. The method of claim 8, wherein analyzing comprises determining a length of time between light pulses in at least one of the portion and the reflected optical signal.

13. The method of claim 8, further comprising determining a length of time between light pulses in at least one of the portion and the reflected optical signal.

14. The method of claim 8, further comprising detecting a background for the optical signal by detecting between the light pulses.

15. The method of claim 8, wherein analyzing comprises comparing a length of time between light pulses for each set of wavelengths in a plurality of wavelengths.

16. The method of claim 8, wherein analyzing comprises subtracting a background signal in the optical signal from a signal for at least one light pulse of the optical signal.

17. The method of claim 8, wherein analyzing comprises determining a ratio.

18. The method of claim 8, further comprising performing time division multiplexing of the optical signal.

19. A computer program product stored on machine readable media, the product for determining deflection of a Fabry-Perot based sensor, the instructions comprising:
providing an optical signal comprising a train of time spaced light pulses, each light pulse comprising a known set of wavelengths;
splitting the optical signal and providing a portion of the optical signal to a reference path;
detecting light pulses in the portion of the optical signal;
using a remaining portion of the optical signal and interrogating the sensor;
receiving a reflected optical signal from the sensor;
detecting light pulses in the reflected optical signal; and
analyzing the portion of the optical signal and the reflected optical signal to determine the deflection.

20. The computer program product as in claim 19, further comprising instructions for performing time division multiplexing of the optical signal.
